(19) United States
(12) Patent Application Publication
(10) Pub. No.: US 2012/0121395 A1
(43) Pub. Date: May 17, 2012

(54) METHOD FOR FABRICATING A GAS TURBINE ENGINE COMPONENT AND A GAS TURBINE ENGINE COMPONENT

(75) Inventors: Gunnar Marke, Trollhattan (SE); Kjell Petersson, Trollhattan (SE)

(73) Assignee: VOLVO AERO CORPORATION, Trollhattan (SE)

(21) Appl. No.: 13/265,856

(22) PCT Filed: Apr. 23, 2009
(86) PCT No.: PCT/SE2009/000209

§ 371 Date: Jan. 25, 2012

(51) Int. Cl. F01D 1/00; B23P 11/00

(52) U.S. Cl. 415/182.1; 29/428

(57) ABSTRACT

A method for fabricating a gas turbine engine component including an inner ring, an outer ring and at least one strut connecting the inner ring with the outer ring includes the steps of connecting the inner ring to the outer ring via a load carrying edge of the strut, and attaching a side face component of the strut in abutment with the load carrying edge after the step of connecting the inner ring to the outer ring has been performed. A as turbine engine component fat by the method is also provided.

### BACKGROUND AND SUMMARY

The invention relates to a method for fabricating a gas turbine engine component comprising an inner ring, an outer ring and at least one strut connecting the inner ring with the outer ring. The invention in particular relates to a method of forming a strut connecting the inner and outer ring. The invention also relates to a gas turbine engine component comprising an inner ring, an outer ring and a set of struts connecting the inner ring with the outer ring.

A gas turbine engine may be used as a jet engine. The term jet engine includes various types of engines, which admit air at relatively low velocity, heat it by combustion and shoot it out at a much higher velocity. Accommodated within the term jet engine are, for example, turbojet engines and turbo-fan engines. The invention will below be described for a turbo-fan engine, but may of course also be used for other engine types.

An aircraft engine of the turbofan type generally comprises a forward fan and booster compressor, a middle core engine, and an aft low pressure power turbine. The core engine comprises a high pressure compressor, a combustor and a high pressure turbine in a serial relationship. The high pressure compressor and high pressure turbine of the core engine are interconnected by a high pressure shaft. The high-pressure compressor, turbine and shaft essentially form a high pressure rotor. The high-pressure compressor is rotatably driven to compress air entering the core engine to a relatively high pressure. This high pressure air is then mixed with fuel in the combustor and ignited to form a high energy gas stream. The gas stream flows aft and passes through the high-pressure turbine, rotatably driving it and the high pressure shaft which, in turn, rotatably drives the high pressure compressor.

The gas stream leaving the high pressure turbine is expanded through a second or low pressure turbine. The low pressure turbine rotatably drives the fan and booster compressor via a low pressure shaft, all of which form the low pressure rotor. The low pressure shaft extends through the high pressure rotor. In civil applications most of the thrust produced is generated by the fan while in military applications most of the thrust produced is generated by the low and high pressure turbines. Engine frames are used to support and carry the bearings, which in turn, rotatably support the rotors. Conventional turbo fan engines have a fan frame, a mid-frame and an aft turbine frame.

These frames may be constructed by a gas turbine engine component comprising an inner ring, an outer ring and at least one strut connecting the inner ring with the outer ring. U.S. Pat. No. 7,370,467 discloses a method for connecting an outer ring to an inner ring in a frame. From FIG. 5 it is evident that a set of struts is introduced into the gap between an inner ring and an outer ring. The struts are attached to bosses present on the inner and outer rings by welding along the connection between the strut and the boss. When the outer and inner ring are aligned and positioned at its intended end position only a relatively small gap between the inner and outer ring is present. For this reason it has shown to be difficult to give room for welding tools to secure the struts to the frame.

It is desirable to facilitate assembly of a gas turbine engine component. It is also desirable to facilitate assembly of a gas turbine engine component by facilitating mounting of a strut which connects an inner ring to an outer ring and thereby secures the inner ring to the outer ring.

According to an aspect of the invention, a gas turbine engine component including an inner ring, an outer ring and at least one strut connecting the inner ring with the outer ring is fabricated in a method including the steps of:
connecting said inner ring to said outer ring via a load carrying edge of a strut, and
attaching a side face component of a strut in abutment with said load carrying edge after the step of connecting said inner to said outer ring have been performed.

The method step of connecting the inner ring to the outer ring via the load carrying edge of the strut may be performed by casting an integrated gas turbine component structure in a single piece. The integrated gas turbine component structure includes the inner ring, the outer ring and said load carrying edge of the strut. In this embodiment the side face component of the strut is attached in abutment with said load carrying edge after the integrated gas turbine component is removed from its casting mould. In this stage the inner ring is attached to the outer ring.

Alternatively, the method step of connecting the inner ring to the outer ring via the load carrying edge of the strut may be performed by attaching the inner ring to the outer ring via the load carrying edge of the strut.

This may be performed by connecting said inner ring to said outer ring via the load carrying edge of the strut by welding said load carrying edge to connect the inner ring to the outer ring. Attachment of the load carrying edge to the inner and outer ring may be performed by welding. The load carrying edge may be constituted by a pillar which is connected directly to the outer and inner ring. The load carrying edge may include stubs located either of the inner or outer ring, or on both of them. Here, with a stub is intended a protrusion being integral with or secured to the inner and/or outer ring. The load carrying edge may alternatively include a stub located on the inner and/or outer ring and a pillar secured to the stub or stubs. With a strut is included a complete structure including a leading edge, possibly a trailing edge and a side face component connecting the leading edge with the trailing edge. A strut is generally designed to transfer load from the inner ring to the outer ring. The strut is generally designed with a streamline contour. The strut may additionally function to guide the flow, thus the strut may also constitute a vane.

Since a major portion of the load imposed on the strut is transferred via the load carrying edge, it is sufficient to attach this part of the strut to the inner and outer ring. Hence, the attachment of the inner ring to the outer ring may be performed by a weld seam at the load carrying edge or by forming the inner ring, outer ring and the load carrying edge as an integrated unit in a casting process. Since the passage between the inner ring and outer ring may be very narrow in certain parts of the engine, room for access by welding tool to secure the inner ring to the outer ring with a weld seam along a complete axial extension of the strut may not always be present. By using the proposed method to attach the inner ring to the outer ring via a load carrying edge, sufficient room for a welding tool is present, due to that the load carrying edge is located relatively closely to an entry or exit of a gas channel formed in the space between the inner and outer rings. At least one weld seam is then performed around the load carrying leading edge so that it is connected to the inner ring and/or the outer ring. The attachment of the inner ring to the outer ring via the load carrying edge may be performed by creating a weld seam between a pillar constituting the load carrying edge and the inner and outer ring. The attachment may also be performing uniting a stub present on the inner or the outer ring strut with a corresponding stub on the other ring, directly to the other ring or via a pillar. A strong weld seam may be created for the load carrying edge, since the edge is located relatively close to the entry or exit of the gas channel formed between the inner and outer rings and access for a welding tool is facilitated such that it is possible to weld around the complete contour of the load carrying edge, at the location or locations where parts of the load carrying edge are united by a weld seam, in order to attach the inner ring to the outer ring. Hence a structural rigidity of the gas turbine engine component may be maintained without requiring that the'side face component being welded to the outer and inner rings at an upper and lower radial rim of the side face component. The strut may thereafter be completed by attaching a side face component of a strut in abutment with the load carrying edge after the step of attaching said inner to said outer ring via said load carrying edge has been performed.

The side face component is preferably attached to the load carrying edge via welding. At least one weld seam is then performed in a radial direction of the component along the load carrying edge between the inner ring and the outer ring. The step of attaching said inner ring to said outer ring via a load carrying edge of a strut may include attachment of the inner ring to the outer ring via a load carrying leading edge and a load carrying trailing edge. The load carrying leading edge and load carrying trailing edge are positioned at a distance relative to each other so as to leave a space in between them. The step of attaching a side face component of a strut in abutment with the load carrying edge includes attachment of the side face component of a strut in the space and in abutment with both the load carrying leading edge and the load carrying trailing edge.

The side face component are thus in this embodiment introduced after the inner and outer rings have been attached to each other via both the leading and trailing edges. By waiting with attaching the side face component to the leading and trailing edges until after the inner and outer ring have been secured to each other via the leading and trailing edges, ample room for access of a welding tool to secure the leading and trailing edges to the inner and outer ring is ensured.

The leading and trailing edges may be formed of solid metal components that are welded to the inner and outer ring.

The side face component may be pushed in a radial direction through an opening arranged in said inner or outer ring to a position adjacent to said load carrying edge before the side face component is attached to the load carrying edge.

In an embodiment of the invention, the side face component is formed of a sheet metal structure. The sheet metal structure may be formed into the side face component by folding a sheet metal blank to form a first and a second side face, each forming a portion of a side face of the strut; a first end face connected with the first and second side face of side face component, the first end face being adapted to bear against an inner surface of the leading or trailing edge; and one or two end portions the one or each being connected with one of the first and second side face of the mid component, the end portion or portions being adapted to bear against an inner surface of the other of the leading or trailing edge.

In another embodiment of the invention, the side face component may be formed by an extruded profile including a first and a second side face of the strut and a first and a second end face connected with the first and second side face of the strut, the first and second end faces being adapted to bear against inner surfaces of the leading or trailing edges.

The side face component may be pushed into a space defined by the leading edge and the trailing edge in a radial direction through a passage arranged in the inner or outer ring. The passage may be formed by cutting up an opening in the inner and/or outer ring.

The side face component may be locked from radial dislocation by stop shoulders arranged at one of the inner or outer ring and by a locking member arranged at the other of the inner and outer ring. It is furthermore possible to attach the side face component to the leading and trailing edges by welding. Since the connection between the side face component and the leading and trailing edges run in the radial direction access is easier in comparison to forming a weld along the axial direction where the side face component abuts to the inner and outer ring.

The invention also relates to a gas turbine engine component comprising an inner ring, an outer ring and at least one strut connecting the inner ring with the outer ring. The strut includes a load carrying edge and a side face component. The load carrying edge has an attachment face, which is facing in an inward direction of the gas turbine engine component. With inwardly is here intended that the attachment face is directed in a direction from an inlet or outlet of the gas turbine engine component which is closest to the load carrying edge. The side face component includes side faces and an end face. The end face is positioned in abutment with the attachment face. In an embodiment the struts are formed by a set of leading and trailing edges of the set of struts, and a set of side face components, where each side face component is connecting a leading and a trailing edge in the set of leading and trailing edges. The side face components are forming side faces of the struts. Each leading edge has a rear attachment face and each trailing edge has a front attachment face, the rear and front attachment faces defining a space receiving the side face component. When the struts are formed by load carrying leading and trailing edges secured to the inner and outer rings and since a side face component may be received in a space defined between the leading and trailing edges. Hence, ample room to allow easy access to secure the leading and trailing edges to the inner and outer rings is provided.

Locking means may be arranged to retain the side face components in the spaces after the side face components are pushed into the spaces.

The inner and/or outer ring may include a set of passages allowing introduction of the side face components into the spaces arranged to receive the side face components.

Further advantageous embodiments and further advantages to the invention emerge from the detailed description below and the claims.

### BRIEF DESCRIPTION OF DRAWINGS

The invention will be explained in further detail below, with reference to embodiments shown on the appended drawings, wherein

FIG. 1 illustrates an aircraft engine according to prior art in a schematic cut side view,

FIG. 2 illustrates a static gas turbine component for the aircraft engine in FIG. 1 in a perspective view,

FIG. 3 illustrates a cross section of a gas turbine engine component comprising an inner ring, an outer ring and at least one strut connecting the inner ring with the outer ring,

FIG. 3a illustrates different embodiments of the leading and trailing edges,

FIG. 3b illustrates an integrated gas turbine component,

FIG. 4 illustrates a front view of a schematic construction of an outer ring,

FIG. 4a illustrates a cross sectional side view of a schematic construction of an upper part of outer ring, taken at the location A-A indicated in FIG. 4,

FIG. 5 illustrates a front view of a schematic construction of an inner ring,

FIG. 5a illustrates a cross sectional side view of a schematic construction of an upper part of an inner ring, taken at the location B-B indicated in FIG. 5,

FIG. 6 illustrates a front view of a schematic construction of a gas turbine engine component including an inner ring, outer ring and a set of leading and trailing edges connecting the inner and outer rings,

FIG. 6a illustrates aside view of the gas turbine engine component, taken at the location C-C indicated in FIG. 6,

FIG. 7 illustrates a side view of a schematic construction of a gas turbine engine component, FIG. 7a illustrates a cross sectional side view of a schematic construction of a gas turbine engine component, taken at the location D-D indicated in FIG. 7,

FIG. 8 illustrates a cross sectional side view of an upper part of a schematic construction of a gas turbine engine component where means for attachment of the side face component are provided,

FIG. 9 illustrates a perspective side view of a strut including a leading edge, a trailing edge and a side face component,

FIG. 10 illustrates an alternative embodiment of a side face component, and

FIG. 11 illustrates a block scheme of a method for fabricating a gas turbine engine component.

### DETAILED DESCRIPTION

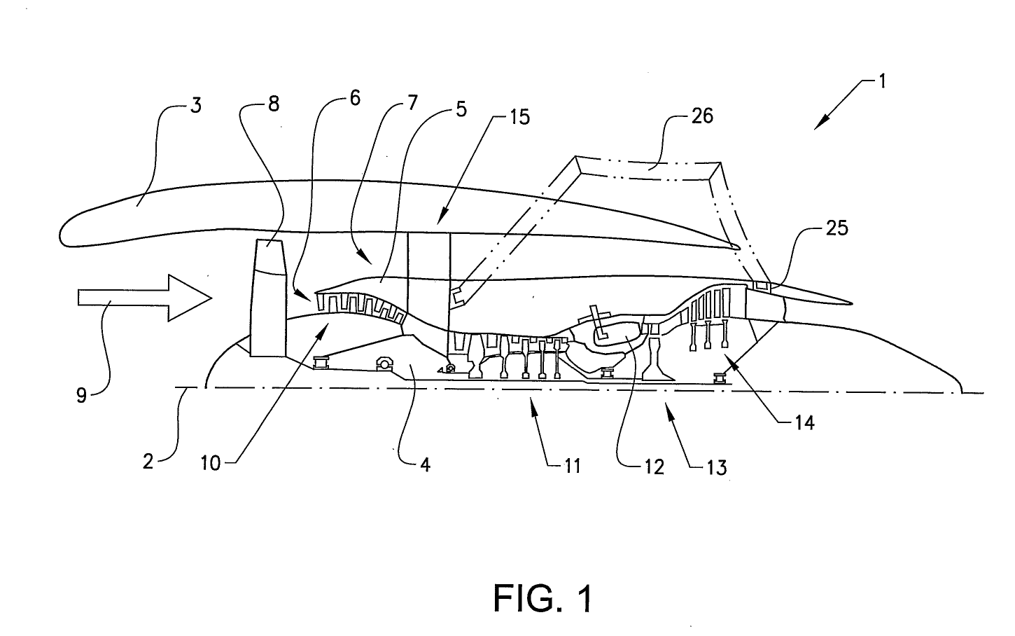

The invention will below be described for a turbofan gas turbine aircraft engine 1, which in FIG. 1 is circumscribed about an engine longitudinal central axis 2. The engine 1 comprises an outer casing 3, or nacelle, an inner casing 4, and an intermediate casing 5, which is concentric to the first two casings and divides the gap between them into an inner primary gas channel 6, or core duct, for the compression of air and a secondary channel 7 in which the engine bypass air flows. Thus, each of the gas channels 6, 7 is annular in a cross section perpendicular to the engine longitudinal central axis 2. The engine I comprises a fan 8 which receives ambient air 9, a booster or low pressure compressor (LPC) 10 and a high pressure compressor (HPC) 11 arranged in the primary gas channel 6, a combustor 12 which mixes fuel with the air pressurized by the high pressure compressor 11 for generating combustion gases which flow downstream through a high pressure turbine (HPT) 13 and a low pressure turbine (LPT) 14 from which the combustion gases are discharged from the engine.

A high pressure shaft joins the high pressure turbine 13 to the high pressure compressor 11 to form a high pressure rotor. A low pressure shaft joins the low pressure turbine 14 to the low pressure compressor 10 to form a low pressure rotor. The high pressure compressor 11, combustor 12 and high pressure turbine 13 are collectively referred to as a core engine. The low pressure shaft is at least in part rotatably disposed co-axially with and radially inwardly of the high pressure rotor. A load carrying, torsionally rigid engine structure 15, in the following referred to as a static component, is arranged between the low pressure compressor 10 and the high pressure compressor 11 in the axial direction of the engine 1. The load carrying static component is also known as a case, housing or frame. The load carrying, torsionally rigid engine structure 15 is highly loaded during certain periods of a normal operating cycle of the engine.

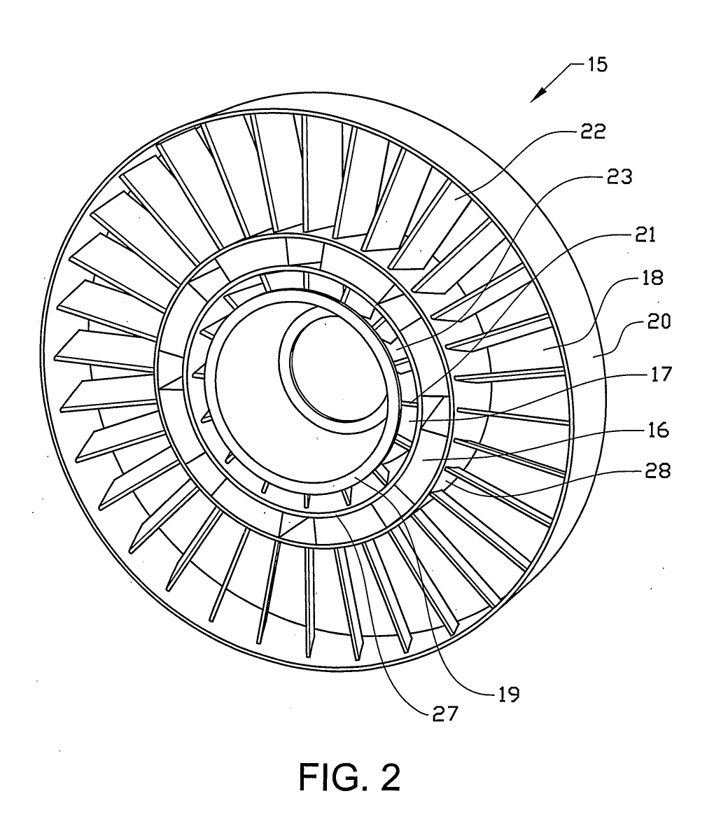

The engine 1 is mounted to the aircraft (not shown) at a forwardly located fan frame forward mount 24 on the static component 15 and at a rearwardly located turbine frame aft mount 25 on the turbine frame. A mount system 26, normally comprising a pylon extending downwards from an aircraft wing and associated thrust links, is schematically indicated in FIG. 1. The mount system 26 is secured to the forward and aft mounts 24, 25. FIG. 2 illustrates a perspective view of the load carrying, torsionally rigid engine structure 15. The load carrying, torsionally rigid engine structure is a static component. The static component 15 comprises an annular intermediate member, or splitter, 16, which defines inner and outer annular passages 17, 18. The inner passage 17 forms part of the inner primary gas channel 6 of the aircraft engine and the outer passage 18 forms part of the secondary channel 7 in which the engine bypass air flows.

The annular intermediate member 16 is supported between an inner annular support member 19 and an outer annular support member 20 by a plurality of circumferentially spaced radial inner and outer struts 21, 22, or stator struts. The inner and outer support members 19, 20 and the annular intermediate member 16 are coannular. Opposite ends of the inner struts 21 are rigidly connected to the inner annular member 19 and the intermediate member 16 for transmitting structural loads between the members. Opposite ends of the outer struts 22 are rigidly connected to the intermediate member 16 and the outer annular member 20 for transmitting structural loads between the members. The air is forced rearwardly through openings between adjacent struts 21, 22. The annular intermediate member 16 comprises an inner ring 27 and an outer ring 28 of metal material. The outer ring 28 together with the outer annular member 20 defines the outer passage 18. The inner ring 27 together with the inner support member 19 defines the inner passage 17.

The method for fabricating a gas turbine engine component can for example be applied when securing the intermediate member 16 to the outer support member 20 or when securing the inner support member 19 to the intermediate member 16. The invention is particularly useful in locations where the space between an inner ring and an outer ring is limited. The space between the inner ring 19 and the outer ring 27 defining the core channel at the static component 15 is very limited. The invention may be used for further gas turbine engine components where an inner ring is attached to an outer ring via a set of struts.

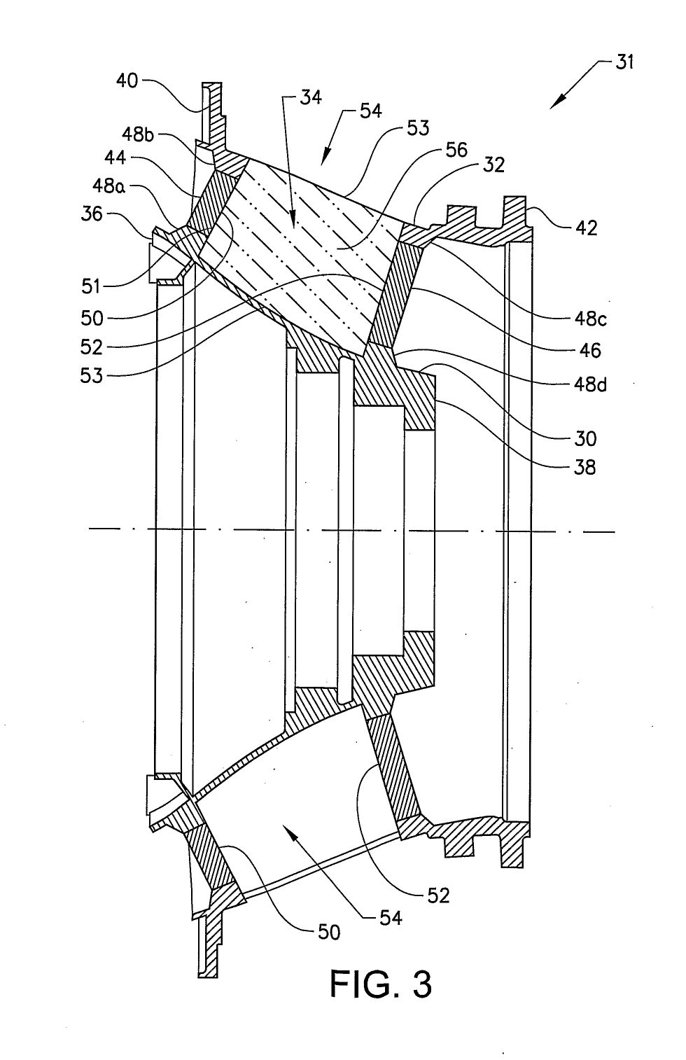

In FIG. 3, a gas turbine engine component 31 according to one embodiment of the invention is illustrated in cross section. The component may be used as the structure defining the core channel at the static component 15 mentioned here above. The gas turbine engine component 31 comprises an inner ring 30, an outer ring 32 and at least one strut 34 connecting the inner ring 30 with the outer ring 32. The inner ring 30 extends from a front flange portion 36 to an end flange portion 38. The outer ring 32 extends from a front flange portion 40 to an end flange portion 42. The flange portions serves for connection to upstream and downstream engine sections. The core channel, where the gas turbine component according to the invention may for example be used, may be defined by an inner and outer ring having radii that are decreasing or increasing in the downstream direction. The outer and inner rings 30, 32 may thus have the shapes of two frustoconical shells.

The inner and outer rings are connected by a set of struts, of which one complete strut 34 is shown in the upper part of the figure. The struts are evenly distributed along the circumphery of the gas turbine engine component. The strut 34 includes a leading edge 44 and a trailing edge 46. The leading edge and trailing edge are formed as load carrying pillars connecting the inner and outer ring 30, 32. The leading and trailing edges may be of solid metal, preferably of a string pressed titanium or titanium alloys. The leading and trailing edges are secured to stubs 48a-48d, formed on the inner and outer rings to form a base for attachment of the leading and trailing edges.

The leading edge 44 has a rear face 50 and the trailing edge 46 has a front face 52, the rear and front face 50, 52 defining a space 54. A side face component 56 is received in the space 54. The side face component 56 may be a sheet metal structure. In the upper part of the figure the side face component 56 has been introduced into the space 54 between the leading and trailing edges, while in the lower part the side face component has not yet been introduced. The space 54 between the leading and trailing edges is therefore clearly visible. The side face component may be introduced via openings present in the inner and/or outer ring.

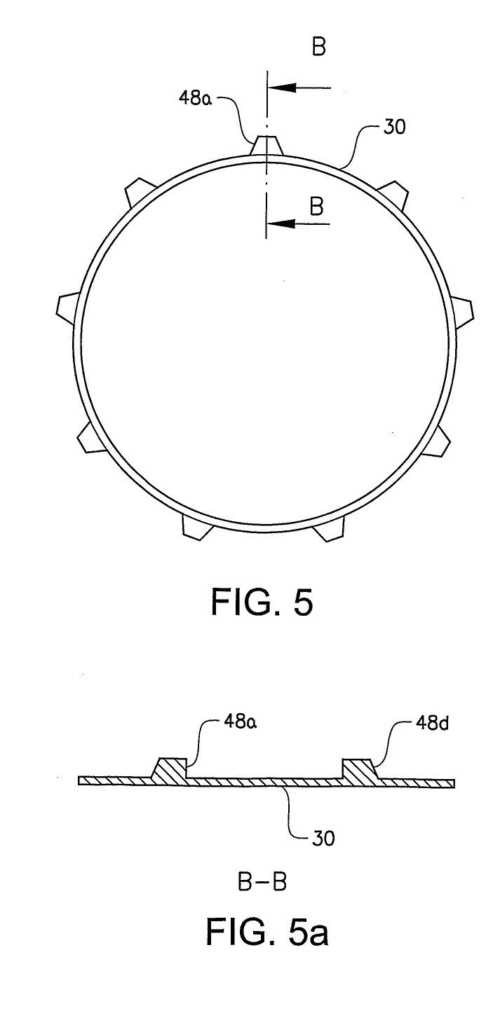

The side face component may be welded to the leading and trailing edges along first, essentially radial interface 51 between the side face component and the load carrying edges. However a second, essentially axial interface 53 between the side face component and the inner and outer ring, is essentially free from a welding seam, unless the part is made accessible form an opening 58 (FIG. 7a), 60 in the inner and or outer ring.

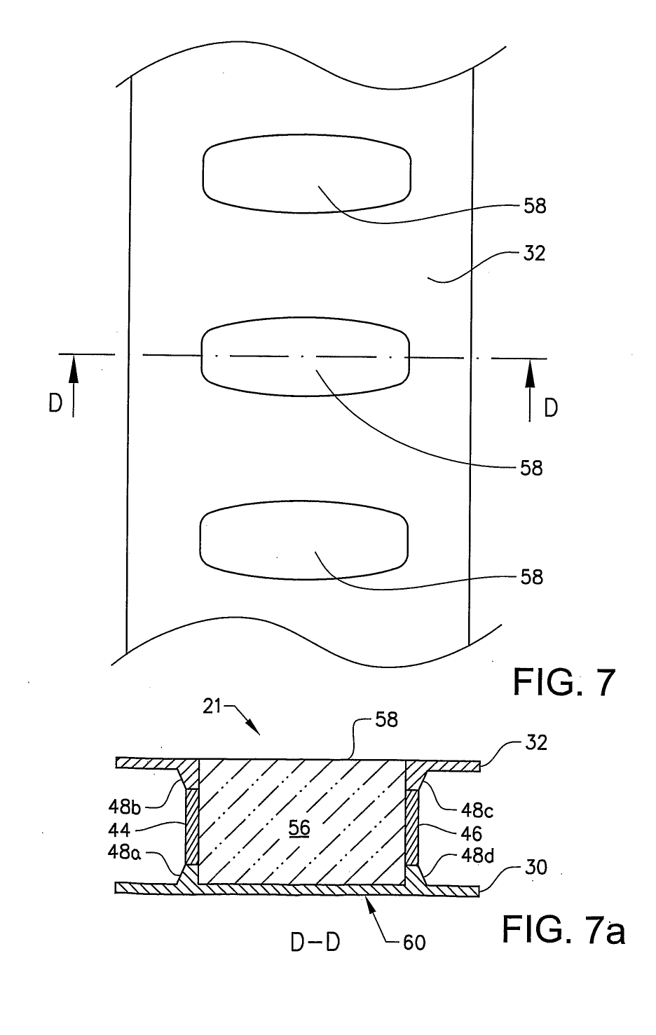

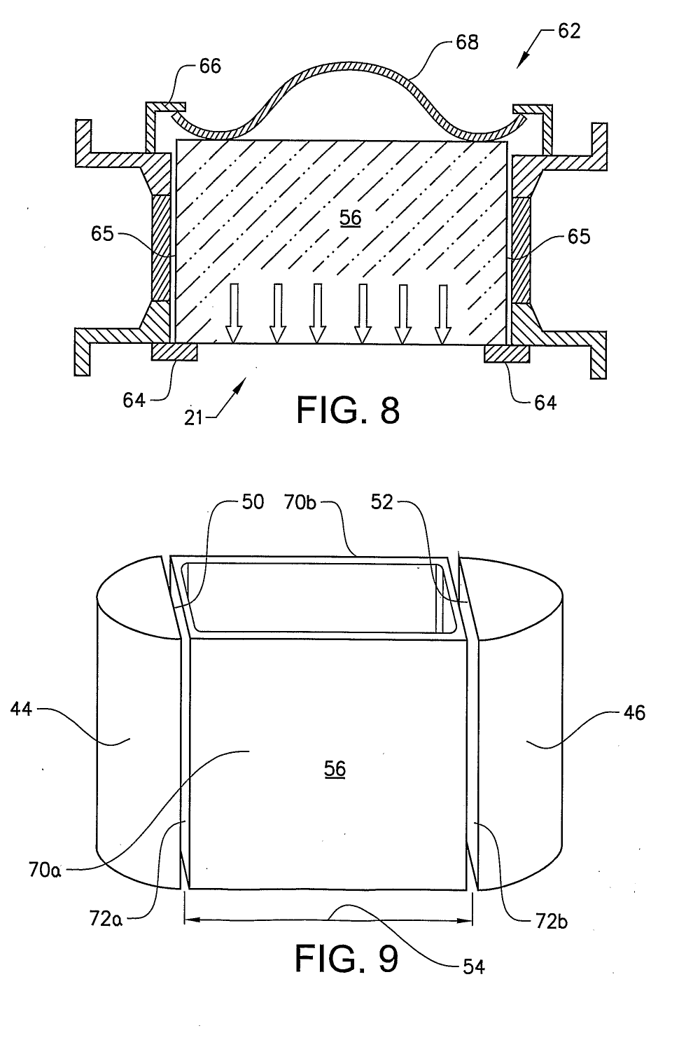

Different embodiments of the side face component 56 are described further below with reference to FIGS. 9 and 10.

In FIG. 3a different embodiments of the leading and trailing edges, 44, 46 are illustrated. The leading edge in the upper part of the figure is composed of a stub integral with the inner ring, which stub extends to and is secured to the outer ring. A joint 55a is thus present at the outer ring. The trailing edge in the upper part of the figure is composed of a stub integral with the inner ring and a stub integral with the outer ring. The respective stubs are connected at a joint 55b to form a trailing edge. The joint 55b is thus present in between the outer and inner rings. The leading edge in the lower part of the figure is composed of a stub integral with the inner ring, a stub integral with the outer ring. and a pillar connecting the stubs.Joints 55c and 55d is thus present at connection between the stubs and the pillar. The trailing edge in the lower part of the figure is composed of a stub connected to the inner ring and a stub connected to the outer ring. The stubs are directly connected to each other. Joints 55e and 55f is thus present at connection between the stubs and the inner and outer rings respectively. In addition a joint 55b between the stub parts secured to the inner and outer rings is present. In FIG. 3b is shown, an integrated gas turbine component structure 33 which is cast in a single piece. The integrated gas turbine component structure 33 includes the inner ring 30, the outer ring 32 and a load carrying leading and trailing edge. In the upper part of the figure a side face component 56 is positioned in a space 54 between the leading and trailing edges. In the lower part, no side face component is present. Instead the gap 54 is clearly visible.

The construction of the leading and trailing edges may be formed in any arbitrary manner. It is however essential that the side face component is secured in abutment to the load carrying leading and/or trailing edges after the inner and outer rings have been secured to each other by the leading and/or trailing edge. Advantageously the strut includes a leading as well as a trailing load carrying edge. However, It may be possible to use only a leading or only a trailing load carrying edge. The extension of the load carrying edges in an-axial direction of the component is less than ⅓ of the total extension of the strut in the axial direction. However, When both a leading and a trailing load carrying edge are used, the space between the load carrying leading edge and the load carrying trailing edge is at least AA of the total extension of the strut in the flow direction.

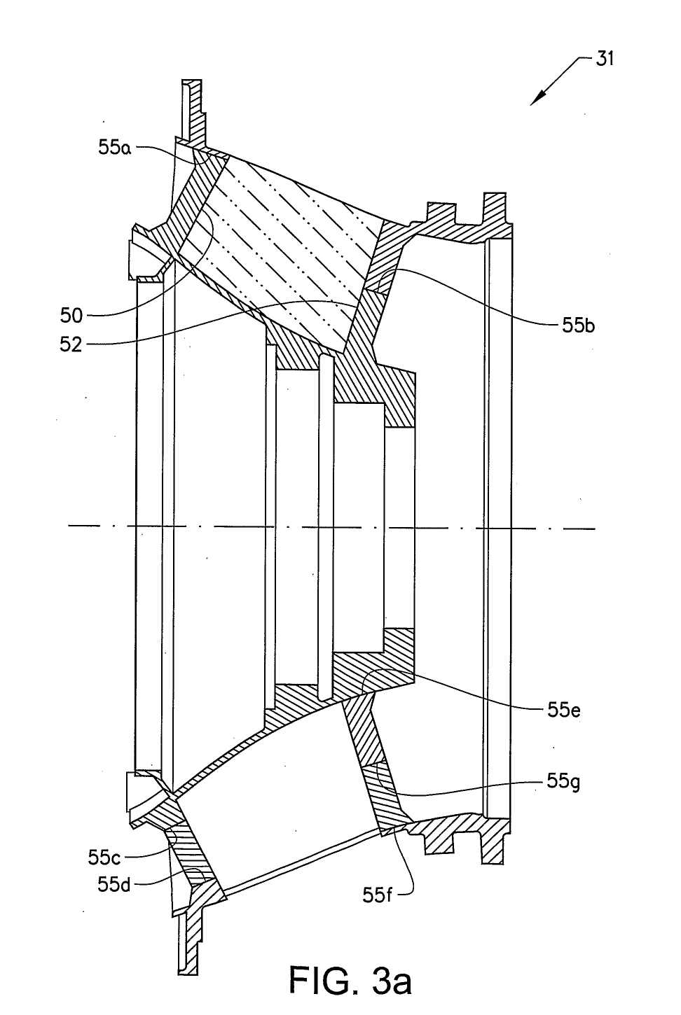

In FIG. 4, a front view of a schematic illustration of an outer ring is made. The outer ring 32 is provided with a front and a rear stub 48b, 48c, see also FIG. 4a.

FIG. 4a illustrates a cross sectional side view of a schematic construction of an upper part of the outer ring, taken at the location A-A indicated in FIG. 4.

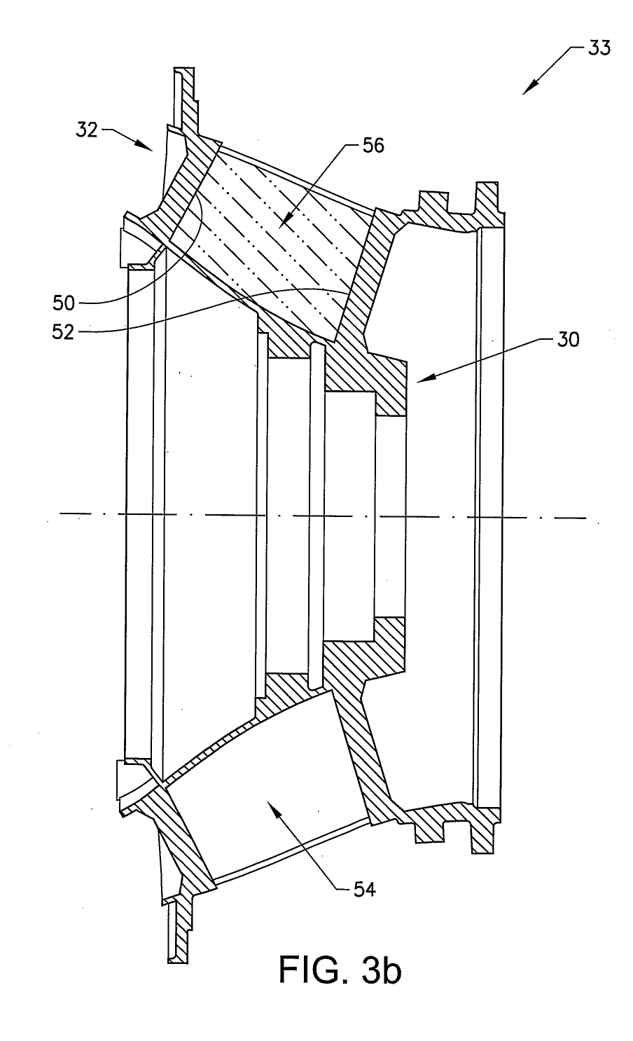

In FIG. 5, a front view of a schematic illustration of an inner ring 30 is made. The inner ring 30 is provided with a front and a rear stub 48a, 48d, see also FIG. 5a adapted to form a base for connection of pillars forming the leading and trailing edges of a strut.

FIG. 5a illustrates a cross sectional side view of a schematic construction of an upper part of an inner ring, taken at the location B-B indicated in FIG. 5.

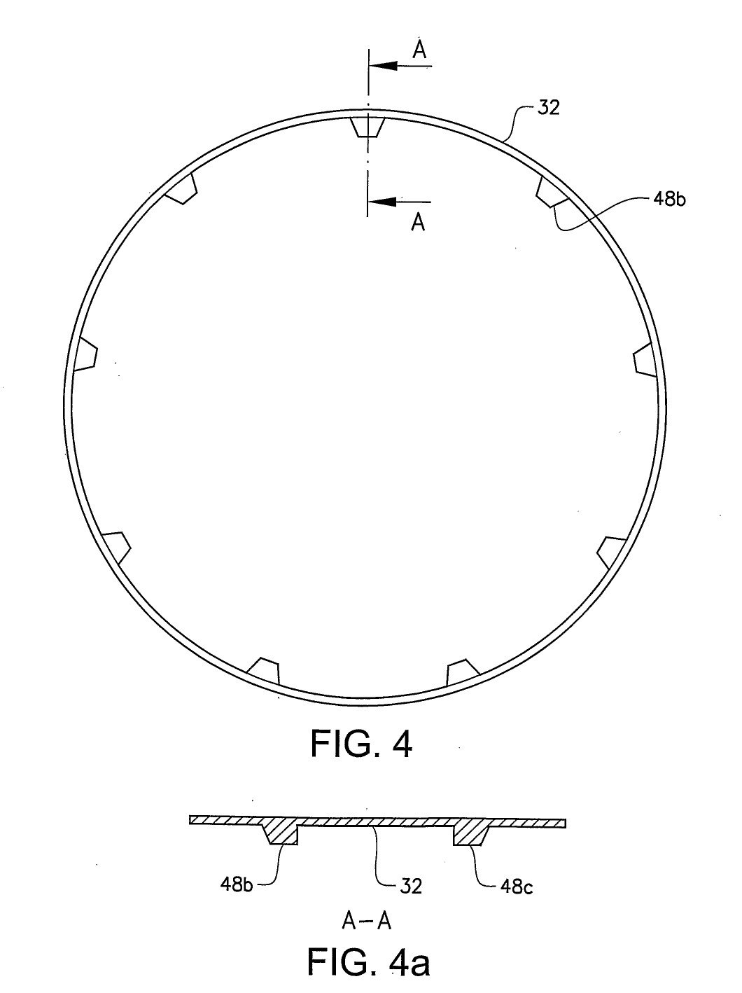

In FIG. 6, a front view of a schematic construction of a gas turbine engine component including an inner ring 30, an outer ring 32 and a set of leading 44 and trailing 46 edges, see also FIG. 6a, connecting the inner and outer rings are illustrated. The leading and trailing edges are secured to the stubs 48a-48d.

FIG. 6a illustrates a side view of an upper part of a schematic construction of a gas turbine engine component, taken at the location C-C indicated in FIG. 6.

In FIGS. 7 and 7a, a side view and a cross-sectional side view of a schematic construction of a gas turbine engine component are illustrated. In FIG. 7 openings 58 in the outer ring 32 are shown. The openings 58 are adapted to allow introduction of side face components 56, that forms the side walls of the struts. In FIG. 7a, a gas turbine engine component including an inner ring 30, an outer ring 32 and a set of leading 44 and trailing 46 edges connecting the inner and outer rings are illustrated. The leading and trailing edges are secured to the stubs 48a-48d. Furthermore, a side face component 56 has been introduced via an opening 58 in the outer ring and is positioned in contact with a surface 60 of the inner ring facing the gas channel. According to an alternative, the side face component 56 is allowed to extend through an opening in the inner ring.

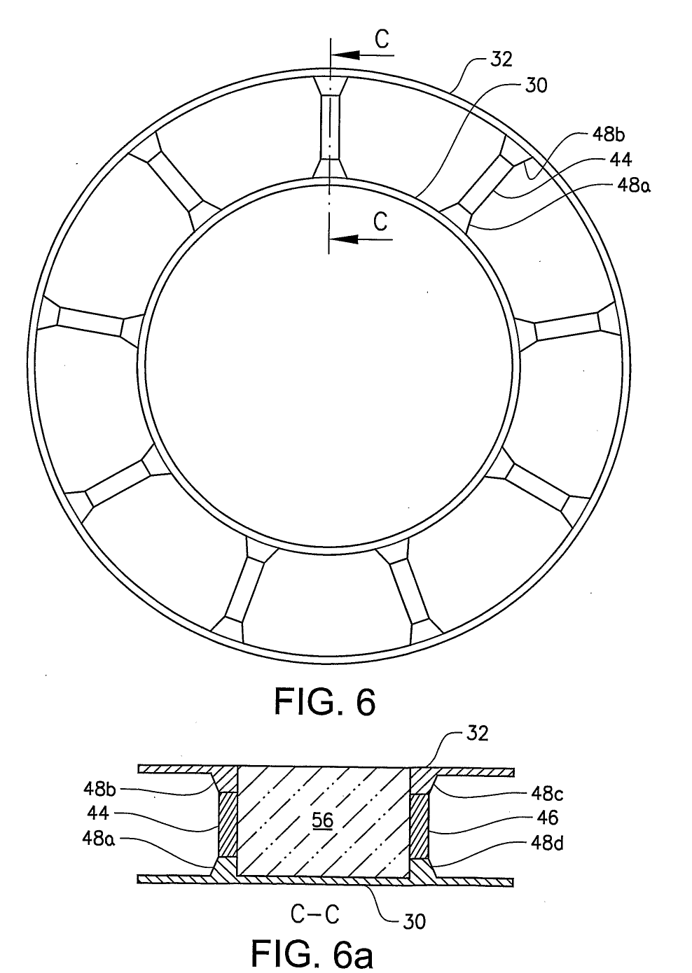

In FIG. 8, a cross sectional side view of an upper part of a schematic construction of a gas turbine engine component is illustrated. Here means 62, such as a fastener, for locking the side face component 56 to the gas turbine engine component are provided to the gas turbine engine component. The locking means may for instance be formed in the form of lips 64 provided on the inner ring preventing the side face component to fall through the opening made in the inner ring 30. On the outer ring brackets or stop shoulders 66 arranged to form support for a spring 68 holding the side face component in intended position are provided. It may also be possible to secure the side face component 56 to the leading and trailing edges 44, 46 by welding.

In FIG. 9, a perspective side view of a strut including a leading edge 44, a trailing edge 46 and a side face component 56. As may be noted the leading and trailing edges 44, 46 are formed by solid metal pillars. The leading edge 44 has a rear face 50 and the trailing edge has a front face 52. A space 54 is provided between the rear face 50 and the front face 52. A side face component 56 is positioned in the space. The side face component 56 includes a first and a second side face 70a, 70b and a first and second end face 72a, 72b. The first and second end faces 72a, 72b are connected with the first and second side face 70a, 70b. The first end face 72a is adapted to bear against the rear face 50 of the leading edge. The second end face 72b is adapted to bear against the front face 52 of the trailing edge. The first and second side faces form part of the side faces of the strut. It is possible to cover the complete strut with a sheet material in order to cover the joint between the leading or trailing edge and the side face component. The side face component may be formed by folding a sheet metal or by string pressing a profile element.

In FIG. 10 an alternative embodiment of a side face component is shown. In this embodiment the said side face component 56 is a sheet metal structure. The sheet metal structure is formed by folding a sheet metal blank to form a first and a second side face 70a, 70b and a first and a second end faces 72a, 72b. The first and second end faces 72a, 72b are connected to the first and second side faces 70a, 70b. The first end face 72a is adapted to bear against an inner surface 50, 52 of the leading or trailing edge 44, 46.

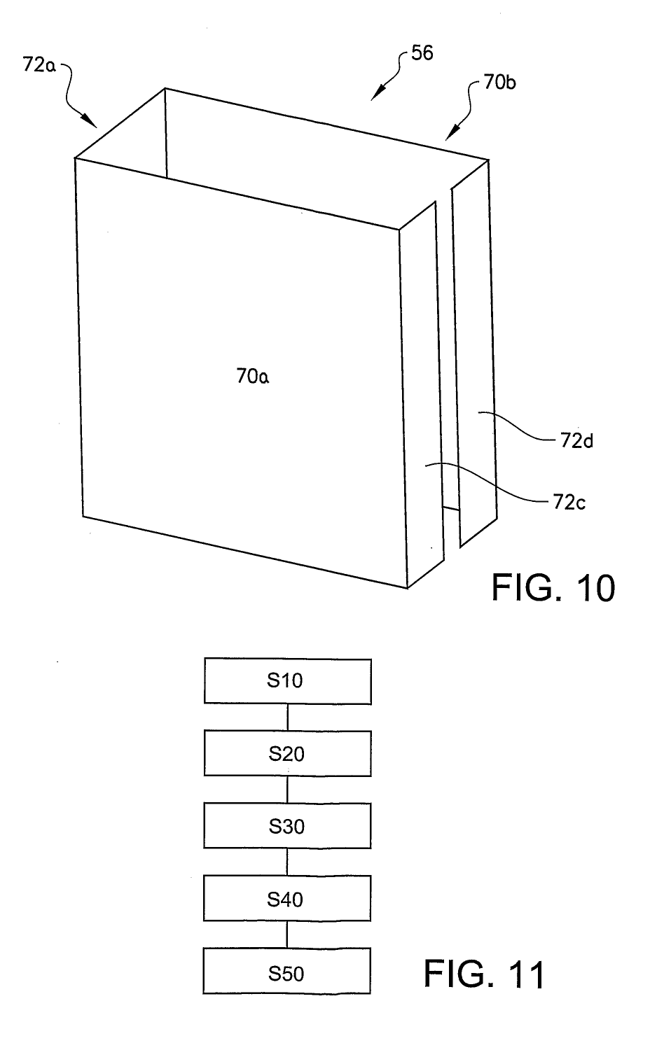

The second end face 72b includes one or two two end portions 72c, 72d. The one or two end portions being connected to one of said first and second side faces 70a, 70b. The end portions or portions being adapted to bear against an inner surface of the other of said leading or trailing edge 44, 46. In FIG. 11, a block scheme of a method for fabricating a gas turbine engine component is shown. In a first method step S10 an inner and outer ring are provided. In a second method step S20 the inner and outer ring are aligned for connection to each other. In a third method step S30 the inner and outer ring are connected via a load carrying edge. The method step 30 may include the method step of connecting the inner and outer rings via both a leading edge and a trailing edge. The load carrying edges may be provided in the form of pillars that may preferably be welded to the inner and outer ring. Alternatively part or the entire leading and trailing edge are integral with or attached to either the inner ring or the outer ring. The load carrying edges can also be formed, or include stubs that are integral with the inner and/or outer ring or secured thereto. A method step of forming a load carrying leading edge and load carrying trailing edge, may thus include the step of attaching a pillar to the inner and outer rings whereby the inner ring is secured to the outer ring, connecting a part of the pillar formed on the inner ring with a part of the pillar formed on the outer ring or alternatively connecting a complete pillar present on either the outer ring or the inner ring to the other ring, securing a pillar to a stub, directly connecting a stub to a ring or to another stub present on the opposite ring. The outer and inner ring are then secured to each other via said load carrying edge. This may be performed by welding the parts of the load carrying edge together. It is possible that the inner ring includes a set of whole pillars and that the outer ring includes the remaining pillars. The inner and outer ring are secured to each other via said pillars prior to introduction of the side face components. In a fourth method step S40 comprises attachment of a side face component of a strut in abutment with said load carrying edge after the step of attaching said inner to said outer ring have been performed.

The step of attaching said inner ring to said outer ring via a load carrying edge of a strut may include attachment of said inner to said outer ring via a load carrying leading edge and a load carrying trailing edge. The load carrying leading edge and load carrying trailing edge are positioned at a distance relative to each other so as to leave a space in between them. The step of attaching a side face component of a strut in abutment with said load carrying edge may includes attachment of the side face component of a strut in said space and in abutment with both said load carrying leading edge and said load carrying trailing edge.

The side face component may suitably be introduced via an opening in the inner and/or outer ring. In a fifth method step S50 the side face component is secured to the gas turbine engine component. The side face component may be secured by fixing the side face component to the leading and/or trailing edges. Alternatively or additionally the side face component may be attached to the inner and/or outer ring. The side face component may be secured by welding, by a locking device or by expanding the side face component when the side face component is located in the space between the leading and trailing edges.

The invention is not limited to the embodiment described above, but can be freely varied within the scope of the claims. For example, the engine component shown in FIG. 3 may be positioned at other positions in the engine such as in the turbine section, between the high pressure turbine and the low pressure turbine.

1. A method for fabricating a gas turbine engine component including an inner ring, an outer ring and at least one strut connecting the inner ring with the outer ring, comprising:
connecting the inner ring to the outer ring via a load carrying edge of the strut, and
attaching a side face component of the strut in abutment with the load carrying edge after connecting the inner ring to the outer ring.

2. A method of fabricating a gas turbine component according to claim 1, wherein connecting the inner ring to the outer ring via the load carrying edge of the strut includes connecting the inner to the outer ring via a load carrying leading edge and attaching the side face component of the strut in abutment with the load carrying edge includes attachment of the side face component of the strut in abutment with the load carrying leading edge.

3. A method of fabricating a gas turbine component according to claims 1, wherein connecting the inner ring to the outer ring via the load carrying edge of the strut is performed by casting an integrated gas turbine component structure in a single piece, the integrated gas turbine component structure including the inner ring, the outer ring and the load carrying edge of the strut.

4. A method of fabricating a gas turbine component according to claims 1, comprising the method step of connecting the inner ring to the outer ring via the load carrying edge of the strut is performed by attaching the inner ring to the outer ring via the load carrying edge of the strut.

5. A method of fabricating a gas turbine component according to claim 4, wherein connecting the inner ring to the outer ring via the load carrying edge of the strut is performed by welding the load carrying edge to connect the inner ring to the outer ring.

6. A method of fabricating a gas turbine component according to claim 1, wherein the load carrying edge is a solid metal component.

7. A method of fabricating a gas turbine component according to claim 1, wherein connecting the inner ring to the outer ring further includes connecting the inner ring to the outer ring via a load carrying trailing edge, the load carrying leading edge and load carrying trailing edge being positioned at a distance relative to each other so as to leave a space in between them, and that attaching the side face component of the strut in abutment with said the load carrying edge includes attachment of the side face component of the strut in the space and in abutment with both the load carrying leading edge and the load carrying trailing edge.

8. A method of fabricating a gas turbine component according to claim 1, wherein the side face component is a hollow structure.

9. A method of fabricating a gas turbine component according to claim 8, wherein the side face component is a sheet metal structure.

10. A method of fabricating a gas turbine component according to claim 7, wherein the side face component comprises a first and a second side face, a first end face connected to the first and second side face, the first end face being adapted to bear against an inner surface of the leading or trailing load carrying edges, and one or two end portions being connected with one of the first and second side faces, the end portions being adapted to bear against an inner surface of the other of the leading or trailing edge.

11. A method of fabricating a gas turbine component according to claim 1, wherein the side face component is pushed in a radial direction through an opening arranged in the inner or outer ring to a position adjacent to the load carrying edge before the side face component is attached to the load carrying edge.

12. A method of fabricating a gas turbine component according to claim 11, wherein the side face component is locked from radial dislocation by stop shoulders arranged at one of the inner or outer ring and by a locking member arranged at the other of the inner and outer ring.

13. A method of fabricating a gas turbine component according to claim 11, wherein the opening is formed by cutting up a hole through the inner and/or outer ring.

14. A method according to claim 1, wherein the inner and/or outer ring includes a set of stubs (48a-48d) to which the load carrying edge is attached by welding.

15. A gas turbine engine component comprising an inner ring, an outer ring and at least one strut connecting the inner ring with the outer ring, wherein the at least one strut includes a load carrying edge and a side face component, where the load carrying edge has an attachment face and the side face component including side faces and an end face, wherein the end face is positioned in abutment with the attachment face.

16. A gas turbine engine component according to claim 15, comprising the at least one strut includes a load carrying leading edge and a load carrying trailing edge, where the load carrying leading edge has a rearwardly facing attachment face and the trailing edge has a forwardly facing attachment face, the rearwardly and forwardly facing attachment faces defining a space receiving the side face component.

17. A gas turbine engine component according to claim 15, wherein locking means are arranged to retain the side face component in a position adjacent to the load carrying edge.

18. A gas turbine engine component according to claim 15, wherein the inner and/or outer ring includes at least one opening allowing introduction of the side face component in a radial direction to a position adjacent to the load carrying edge

19. A method for fabricating a gas turbine engine component including an inner ring, an outer ring and at least one strut connecting the inner ring with the outer ring, the method including:
connecting the inner ring to the outer ring via a load carrying edge of the strut, and
attaching a side face component of the strut in abutment with the load carrying edge after connecting the inner ring to the outer ring have been performed.

20. A method of fabricating a gas turbine component according to claim 19, wherein connecting the inner ring to the outer ring via the load carrying edge of the strut includes connecting the inner to the outer ring via a load carrying leading edge and that attaching the side face component of the strut in abutment with the load carrying edge includes attachment of the side face component of the strut in abutment with the load carrying leading edge.

21. A method of fabricating a gas turbine component according to claims 19, wherein connecting the inner ring to the outer ring via the load carrying edge of the strut is performed by casting an integrated gas turbine component structure in a single piece, the integrated gas turbine component structure including the inner ring, the outer ring and the load carrying edge of the strut.

22. A method of fabricating a gas turbine component according to claims 19, wherein connecting Said the inner ring to the outer ring via the load carrying edge of the strut is performed by attaching the inner ring to the outer ring via the load carrying edge of the strut.

23. A method of fabricating a gas turbine component according to claim 22, wherein connecting the inner ring to the outer ring via the load carrying edge of the strut is performed by welding the load carrying edge to connect the inner ring to the outer ring.

24. A method of fabricating a gas turbine component according to claim 19, wherein the load carrying edge is a solid metal component.

25. A method of fabricating a gas turbine component according to claim 19, wherein connecting the inner ring to the outer ring further includes connecting the inner ring to the outer ring via a load carrying trailing edge, the load carrying leading edge and load carrying trailing edge being positioned at a distance relative to each other so as to leave a space in between them, and that attaching the side face component of the strut in abutment with the load carrying edge includes attachment of the side face component of the strut in the space and in abutment with both the load carrying leading edge and the load carrying trailing edge.

26. A method of fabricating a gas turbine component according to claim 19, wherein the side face component is a hollow structure.

27. A method of fabricating a gas turbine component according to claim 26, wherein the side face component is a sheet metal structure.

28. A method of fabricating a gas turbine component according to claim 25, wherein the side face component comprises a first and a second side face, a first end face connected to the first and second side face, the first end face being adapted to bear against an inner surface of the leading or trailing load carrying edges, and one or two end portions being connected with one of the first and second side faces, the end portions being adapted to bear against an inner surface of the other of the leading or trailing edge.

29. A method of fabricating a gas turbine component according to claim 19, wherein the side face component is pushed in a radial direction through an opening arranged in the inner or outer ring to a position adjacent to the load carrying edge before the side face component is attached to the load carrying edge.

30. A method of fabricating a gas turbine component according to claim 29, wherein the side face component is locked from radial dislocation by stop shoulders arranged at one of the inner or outer ring and by a locking member arranged at the other of the inner and outer ring.

31. A method of fabricating a gas turbine component according to claim 29, wherein the opening is formed by cutting up a hole through the inner and/or outer ring.

32. A method according to claim 19, wherein the inner and/or outer ring includes a set of stubs to which the load carrying edge is attached by welding.

33. A gas turbine engine component comprising an inner ring, an outer ring and at least one strut connecting the inner ring with the outer ring, wherein the at least one strut includes a load carrying edge and a side face component, where the load carrying edge has an attachment face and the side face component including side faces and an end face, wherein the end face is positioned in abutment with the attachment face.

34. A gas turbine engine component according to claim 33, wherein the at least one strut includes a load carrying leading edge and a load carrying trailing edge, where the load carrying leading edge has a rearwardly facing attachment face and the trailing edge has a forwardly facing attachment face, the rearwardly and forwardly facing attachment faces defining a space receiving the side face component.

35. A gas turbine engine component according to claim 33, wherein locking means are arranged to retain the side face component in a radial direction to a position adjacent to the load carrying edge.

36. A gas turbine engine component according to claim 33, wherein the inner and/or outer ring includes at least one opening allowing introduction of the side face component in a radial direction to a position adjacent to the load carrying edge.
